(19) United States
(12) Patent Application Publication
(10) Pub. No.: US 2024/0158897 A1
(43) Pub. Date: May 16, 2024

(54) MATERIAL AND PROCESS FOR MANUFACTURING OF METAL PARTS WITH LOW DENSITY AND GOOD MECHANICAL PROPERTIES

(71) Applicant: BASF SE, Ludwigshafen am Rhein (DE)

(72) Inventors: Guan HUANG, Shanghai (CN); Martin BLOEMACHER, Meckenheim (DE); Marie-Claire HERMANT, Ludwigshafen am Rhein (DE)

(21) Appl. No.: 18/272,117

(22) PCT Filed: Jan. 13, 2022
(86) PCT No.: PCT/EP2022/050601

§ 371 Date: Jul. 13, 2023

(30) Foreign Application Priority Data
Jan. 20, 2021 (WO) PCT/CN2021/072859

(51) Int. Cl. C22C 38/38; B22F 1/103; B22F 3/10; B22F 3/22; B22F 10/18; B22F 10/62; B22F 10/64; C22C 38/06; C22C 38/28; B33Y 10/00; B33Y 40/20; B33Y 70/10; B33Y 80/00

(52) U.S. Cl. CPC C22C 38/38; B22F 1/103; B22F 3/1025; B22F 3/225; B22F 10/18; B22F 10/62; B22F 10/64; C22C 38/06; C22C 38/28; B33Y 10/00; B33Y 40/20; B33Y 70/10; B33Y 80/00

(57) ABSTRACT

The invention relates to composition comprising (a) from 40 to 70% by volume of a metal powder, based on the total volume of the composition, in which the metal powder is an alloy comprising: (a1) from 4.0 to 13.0% by weight of chromium, (a2) from 6 to 15% by weight of aluminum, 0(a3) from 4 to 30% by weight of manganese, (a4) from 38.4 to 85.95% by weight of iron, (a5) from 0.05 to 0.5% by weight of titanium, (a6) from 0% to 0.2% by weight of nickel, (a7) from 0% to 1.5% by weight of silicon, 5(a8) from 0% to 1.5% by weight carbon, all based on the total weight of the metal powder; and (b) from 30 to 60% by volume, based on the total volume of the composition, of a polymeric binder. Furthermore, the invention relates to the use of such composition in metal injection molding or additive manufacturing as well as the use of the metal powder in a binder-into-bed jetting process.

This invention relates to the production of metal parts with densities below 7.4 g/cm³, tensile strengths of 600 MPa or more and ductilities of 5% or more, on an iron-based metal powder with a chemical composition including the elements aluminum and manganese.

### BACKGROUND OF THE INVENTION

Metallic parts can be produced by various methods including (1) injection molding of thermoplastic molding materials which contain metal powders and organic binders, (2) 3D printing of thermoplastic molding materials which contain metal powders and organic binders and (3) 3D printing of metal powders using organic binders in a inkjet printing-like process. These three processes are similar in the fact that they all yield green bodies, which comprise metal powders and organic binders, that are subsequently treated in similar post-processing steps to reach the final, dense, fully metallic state.

For methods (1) and (2), the organic binder materials are highly loaded with the metal powders and the resultant composite is called a feedstock. After injection molding, extruding, 3D printing (using either granule, rod/bar or filament forms of the feedstock) or pressing the filled thermoplastic molding materials or feedstock to form a green body, the organic binder is removed (so called debinding) and the debinded green body or brown body is sintered. For metals and injection molding this process is known as metal injection molding (MIM), e.g. from U.S. Pat. No. 5,737,683. The use of MIM feedstocks in 3D printing processes is generally known from WO 2016/012 486.

For process (3) the metal powders are contained in a packed bed and using an inkjet printing system, binders are introduced into the bed thereby binding powders within a layer. By lowering the bed surface, bringing a fresh layer of powder onto this surface and repeating the inkjet process, finally a green body is created which can be extracted from the powder bed. This process is commonly called binder-into-bed jetting (BBJ), e.g. in U.S. Pat. No. 5,204,055.

MIM is a versatile, low waste industrialized process extensively used in the automotive, industrial and information and communication technology (ICT) industry for the production of various metal parts going into, for example, mobile phones and accessories, computers, tablets and earphones, locks and pump-parts, moving engine parts and sensor-units.

BBJ is a process that is finding increased industrial adoption in the production of plastic and metal parts. Many MIM-players are also looking closely to this process for the low-waste, flexible production of metal parts for use in the automotive, industrial and information and communication technology (ICT) industry.

Weight reduction of consumer goods, automobiles and industrial machines is commonplace due to the increased awareness of the environmental impact of transporting goods, people and machines. Light weighting is commonly achieved by reducing material usage through clever design or the use of stronger materials. Alternatively, lighter raw materials, i.e. materials having a lower density, may offer a more elegant solution, especially when comparable mechanical performances can be achieved.

In the iron-based metal part production industry, solutions for light-weight metal parts without any reduction in performance is highly sought after, as weight is a large disadvantage of using steel. Furthermore, in the fields of structural parts in electronic devices such as mobile phones, computers or laptops, only through lighter materials metal parts can still be applied since the total number of parts per device are steadily increasing, and customers can only allow for small weight increases in the final device.

In MIM the use of light-weight metals like Al, Ti or Mg, and alloys thereof has been under discussion for many years. They all have a tremendous potential for reducing the weight of a device, but they also have their challenges. Pure metal powders of these elements are often highly reactive in air and dangerous to work with under ambient conditions. Making stable feedstocks of these materials and processing the parts in a safe way remains difficult. Sintering parts to its final density presents an even bigger challenge. BBJ of such light-weight materials also faces similar challenges, since a similar sintering process is required, as well as a safe handling of the reactive metal powders.

Finally, consumer goods have certain aesthetic requirements and they must simultaneously demonstrate good corrosion resistance under atmospheric environments. Furthermore, electronic devices are used numerous times a day and need to withstand certain mechanical loads during use. The mechanical properties of such light-weight metal parts must be similar to common steels used in the ICT industry, for example 17-4PH or 316L.

In conclusion, the market has defined the need for metal powders and MIM feedstocks based on a metal alloy that is corrosion resistant with good mechanical properties, a low density and applicable in an industrial MIM production facility or in BBJ processes.

The use of cast or forged steel containing increased amounts of aluminum and manganese has gained much ground in the automotive industry in the past years (Sci. Tech. Adv. Mat. 2013, 14, 014205). Such materials have already been published in the 1950s, where the potential for low density materials with interesting properties was already identified (U.S. Pat. No. 3,193,384). Published works for melt-cast parts with and without subsequent heat treatments having 3 to 13% aluminum, 3 to 30% manganese and 0.1 to 1.5% carbon report tensile strengths reaching more than 1 GPa (Sci. Tech. Adv. Mat. 2013, 14, 014205). Pow. Metall. 2019, 62, 3 discloses a metal powder with a composition of 1.5% aluminum, 22% manganese, 0.4% carbon, 1.5% silicon, and the balance iron, that was successfully converted to a MIM feedstock, however no mechanical properties and final part densities were given. Many austenitic systems are achieved using specific compositions and heat treatments, increasing the possibility of acceptable corrosion resistance of such parts based on these systems.

Key to achieving the extraordinary properties demonstrated for cast or forged materials, after following the MIM-technology or BBJ-technology route, is the high sintered part density which needs to be reached (over 99% of theoretical density is favourable). Only this high density and the avoidance of distortion can make this alloy feasible for the industry. Taking into consideration that the sintered density of MIM-parts or BBJ-parts are typically 3-5% below the density of wrought steel, it is clear that it is non-trivial to achieve the good properties of this steel using the MIM or BBJ-route.

The alloys described in Sci. Tech. Adv. Mat. 2013, 14, 014205 and Pow. Metall. 2019, 62, 3 contain substantial amounts of aluminum and manganese which can make debinding and sintering difficult. Aluminum and manganese react readily with oxygen and other oxidizing agents. Manganese also has a very low partial pressure thereby causing it to deplete from parts during sintering at high temperatures. It is therefore clear, that the application of such an alloy in the MIM or BBJ process is non-trivial.

The object underlying the present invention is to provide a metal powder, formulation and process that do not have the above-mentioned drawbacks. In particular, it is an object of the present invention to provide
(1) a MIM formulation and process and
(2) a use and process of using the metal powder
for manufacturing of complex metal parts that show densities below 7.4 g/cm² and exhibit good mechanical properties such as a tensile strength of 600 MPa or more or an elongation at break of 5% or more, preferably both. In addition, green bodies manufactured from the MIM formulation should be debindable, preferably catalytically debindable.

### SUMMARY OF THE INVENTION

A first aspect of the present invention is a composition comprising
(a) from 40 to 70% by volume of a metal powder, based on the total volume of the composition, in which the metal powder is an alloy comprising:
   (a1) from 4.0 to 13.0% by weight of chromium,
   (a2) from 6 to 15% by weight of aluminum,
   (a3) from 4 to 30% by weight of manganese,
   (a4) from 38.4 to 85.95% by weight of iron,
   (a5) from 0.05 to 0.5% by weight of titanium,
   (a6) from 0% to 0.2% by weight of nickel,
   (a7) from 0% to 1.5% by weight of silicon,
   (a8) from 0% to 1.5% by weight carbon,
   all based on the total weight of the metal powder; and
(b) from 30 to 60% by volume, based on the total volume of the composition, of a polymeric binder.

When using the subject composition, metal parts with densities below 7.4 g/cm³ may be manufactured.

When considering the metal powder composition embodied in this invention, more specifically the presence of aluminum and manganese, it is surprising that the metal powder can be sintered to achieve sintered parts with high relative densities, particularly when following the catalytic debinding MIM process.

As used herein, “relative density” herein means the relation of the density of the final metal parts (also referred to as “metal part density” or simply “density”) to the theoretical density. As used herein, “theoretical density” means the maximum density of the metal being fully dense without any closed porosity therein.

After the heat-treatment according to the invention, the final metal parts exhibit mechanical properties and a corrosion behavior known for forged and cast parts using a similar alloy composition, particularly ultimate tensile strength of 600 MPa or more, an elongation at break of 5% or more, or preferably both.

A second aspect of the present invention is the use of the composition described herein in a metal injection molding process or in an additive manufacturing process to form metal parts.

A third aspect of the present invention is a process for manufacturing a metal part by metal injection molding comprising
(I) providing a composition as describe herein;
(II) injection molding the composition to form a green body;
(III) catalytically debinding the green body with an acid to form a brown body;
(IV) sintering the brown body under a non-oxidative atmosphere, atmospheric or reduced pressure, and a temperature of from 1 150 to 1 300° C. to form a sintered part;
(V) heat-treating the sintered parts with a solution annealing and/or precipitation hardening process.

The specific choice of a sinter and heat-treatment profile allows for the effective implementation of this composition into a MIM-process to deliver these exceptional mechanical properties with metal part densities below 7.4 g/cm³.

A fourth aspect of the present invention is a process for manufacturing a metal part by additive manufacturing comprising
(I) providing a composition as described herein;
(II) subjecting the composition to a fused filament fabrication step to form a green body;
(III) catalytically debinding the green body with an acid to form a brown body;
(IV) sintering the brown body under a non-oxidative atmosphere, at atmospheric or reduced pressure, and a maximum temperature of from 1 150 to 1300° C. to form a sintered part;
(V) optionally heat-treating the sintered parts with a solution annealing and/or precipitation hardening process.

A fifth aspect of the present invention is the use of a metal powder for manufacturing metal parts by a binder-into-bed jetting additive manufacturing process, wherein the metal powder consists of an alloy comprising:
(a1) from 4.0 to 13.0% by weight of chromium,
(a2) from 6 to 15% by weight of aluminum,
(a3) from 4 to 30% by weight of manganese,
(a4) from 38.4 to 85.95% by weight of iron,
(a5) from 0.05% to 0.5% by weight of titanium,
(a6) from 0 to 0.2% by weight of nickel,
(a7) from 0 to 1.5% by weight of silicon,
(a8) from 0 1.5% by weight carbon,
all based on the total weight of the metal powder.

A sixth aspect of the present invention is a process for manufacturing a metal part by additive manufacturing comprising
(I) providing a metal powder, the metal powder being an alloy comprising:
   (a1) from 4.0 to 13.0% by weight of chromium,
   (a2) from 6 to 15% by weight of aluminum,
   (a3) from 4 to 30% by weight of manganese,
   (a4) from 38.4 to 85.95% by weight of iron,
   (a5) from 0.05 to 0.5% by weight of titanium,
   (a6) from 0 to 0.2% by weight of nickel,
   (a7) from 0 to 1.5% by weight of silicon,
   (a8) from 0 to 1.5% by weight carbon;
(II) subjecting the metal powder to a binder-into-bed jetting step to form a green body;
(III) debinding and sintering the green body under a non-oxidative atmosphere, under atmospheric or reduced pressure, and a temperature of from 1 150° C. to 1 300° C. to form a sintered part;
(IV) optionally heat-treating the sintered part with a solution annealing and/or precipitation-hardening process.

The specific choice of a sinter and heat-treatment profile allows for the effective implementation of this alloy into a BBJ-process to deliver these exceptional mechanical properties with densities below 7.4 g/cm².

### DETAILED DESCRIPTION OF THE INVENTION

The metal powder described below may be used in the MIM feedstocks according to the invention but may also be used directly in a BBJ-process as further illustrated herein. Both lead to metal parts.

### Metal Powder

The metal powder consists of a pulverant metal alloy material comprising or essentially consisting of:
(a1) from 4.0 to 13.0% by weight of chromium,
(a2) from 6 to 15% by weight of aluminum,
(a3) from 4 to 30% by weight of manganese,
(a4) from 38.4 to 85.95% by weight of iron,
(a5) from 0.05 to 0.5% by weight of titanium,
(a6) from 0 to 0.2% by weight of nickel,
(a7) from 0 to 1.5% by weight of silicon,
(a8) from 0 to 1.5% by weight carbon,
all based on the total weight of the metal powder.

As used herein, “essentially” here means that there may be minor amounts of other components, in particular, unavoidable impurities that do not significantly influence the chemical and mechanical properties of the alloy.

Chromium, Cr, contributes to the corrosion resistance of the metal. Cr is a ferrite stabilizer, and should, at least for that reason, not be too high in content. It has a lower heat of combustion value than other essential elements in the metal and could therefore be used to compensate for the more negative impact of Al in that respect. The amount of Cr in the metal is from 4.0 to 13.0% by weight, preferably from 4.5 to 11.0% by weight, most preferably from 5.0 to 9.0% by weight.

Aluminum, Al, is used for lowering the density of the metal and for contributing to the strength of the metal by forming carbides, or by forming nitrides if nitrogen is present in the steel. Al is a ferrite stabilizer. It also has a high heat of combustion value, thereby adding to the explosion tendency of a powder. At least for the latter reason, the amount of aluminum should not be too high. The metal powder has an aluminum content of 6.0% by weight or more, particularly 6.5% by weight or more. The amount of Al in the metal is from 6 to 15% by weight, preferably from 6.2 to 13% by weight, most preferably from 6.5 to 10% by weight.

Manganese, Mn, is used as the main austenite stabilizer. The amount of Mn in the metal is from 4 to 30% by weight. Preferred amounts of manganese in the metal powder are from 6 to 28% by weight, particularly 10 to 25% by weight. In particularly preferred embodiments the metal powder has a manganese content of 16.5% by weight or more, particularly 19% by weight or more.

Titanium, Ti, contributes to the strength of the metal by forming carbides and/or nitrides. Ti stabilizes ferrite and has a high heat of combustion value. It is therefore only present in an amount of from 0.05 to 0.5% by weight in the metal, preferably from 0.1 to 0.4% by weight, most preferably from

Nickel, Ni, may be present up to 0.2% by weight. Above that level, Ni may cause allergic reactions for people being allergic to nickel. Preferably the nickel content of the metal powder is below 0.05% by weight. Absence of Ni from the powder will remedy the problem completely and therefore, most preferably, the amount of nickel is 0% by weight, i.e. the metal powder is free of nickel.

Silicon, Si, makes the melt more fluid and thereby facilitates the atomization process. Si also has a low density. However, Si stabilizes ferrite and has a high heat of combustion value. It is therefore only present in the from 0 to 1.5% by weight, preferably from 0.15 to 0.35% by weight.

Carbon, C, may be used as a carbide-former, thereby adding mechanical strength to the metal, and preventing to some extent the formation of unwanted intermetallic phases. It may be present in an amount up to 1.5% by weight, preferably from 0.5 to 1.4% by weight, most preferably from 0.7 to 1.3% by weight.

Nitrogen, N, may be present up to 0.6% by weight in the metal powder. However, too much N may result in large amount of precipitates with a risk of reducing ductility of the metal.

Iron, Fe, is used as balance in an amount of from 38.4 to 85.95% by weight, i.e. it sums up with the other components to 100% by weight. Furthermore, the metal may contain minor amounts of unavoidable impurities that do not significantly influence the chemical and mechanical properties of the alloy.

Preferably the metal powder essentially consists of a pulverant metal alloy material comprising or essentially consisting of:
(a1) from 4.5 to 11.0% by weight of chromium,
(a2) from 6.2 to 13% by weight of aluminum,
(a3) from 6 to 28% by weight of manganese,
(a4) from 44.65 to 82.3% by weight of iron,
(a5) from 0.1 to 0.4% by weight of titanium,
(a6) from 0 to 0.15% by weight of nickel,
(a7) from 0.4 to 1.4% by weight of silicon,
(a8) from 0.5 to 1.4% by weight carbon.

More preferably the metal powder (MP) consists of a pulverant metal alloy material comprising or essentially consisting of:
(a1) from 5.0 to 9.0% by weight of chromium,
(a2) from 6.5 to 10% by weight of aluminum,
(a3) from 10 to 25% by weight of manganese,
(a4) from 52.95 to 76.95% by weight of iron,
(a5) from 0.15 to 0.35% by weight of titanium,
(a6) from 0 to 0.1% by weight of nickel,
(a7) from 0.6 to 1.3% by weight of silicon,
(a8) from 0.7 to 1.3% by weight of carbon.

These metals are alloyed within one powder. The use of a single, fully alloyed or pre-alloyed powder is preferred. This ensures the homogeneous distribution of elements throughout the final metal part microstructure, ensuring an optimal mechanical performance and corrosion resistance.

For the preparation of the metal powder, the inorganic material has to be pulverized. To pulverize the inorganic material, any method known to the person skilled in the art may be used. For example, the inorganic material may be ground. The grinding for example may take place in a classifier mill, in a hammer mill or in a ball mill.

Metal powders for use in MIM feedstocks or directly in a BBJ process may also be atomized using gas or water atomization. Atomization of these powders are typically performed under inert atmospheres such as Argon and Nitrogen. Argon is often preferred as nitrogen has the disadvantage of being incorporated into the powder microstructure. Resulting nitrides may be disadvantageous for the final sinter part performance.

Beneficial for the use in both MIM and BBJ is a spherical powder with a particle size distribution generally from 0.005 to 100 μm, preferably from 0.1 to 70 μm, particularly preferably from 0.2 to 30 μm, most preferably from 0.3 to 20 μm measured by laser diffraction. The mean particle size (diameter) of the powder is preferably below 100 μm, more preferably below 50 μm, most preferably below 20 μm. Powders may be sieved or classified after atomization to reach the desired particle size distributions. Plasma-treatments of the powders may also be utilized to improve the powder sphericity and to remove contaminants.

In a first embodiment of the invention the metal powder may be used in form a MIM feedstock composition

### MIM Feedstock

The composition according to the invention, also more specifically referred to herein as “MIM feedstock” or “feedstock”, comprises from 40 to 70% by volume of the metal powder as describe above and from 30 to 60% by volume of a binder, based on the total volume of the mixture. It has to be notated that the term “MIM feedstock” does not intend to restrict its use to MIM but the composition may also be used in Additive Manufacturing and other potential applications.

Preferably, the feedstock comprises or essentially consists of from 45 to 65% by volume of the metal powder and from 35 to 55% by volume of the binder, based on the total volume of the feedstock.

Particularly preferably, the feedstock comprises from 50 to 64% by volume of a metal powder and from 36 to 50% by volume of a binder, based on the total volume of the feedstock.

Preferably the feedstock essentially consists of the metal powder and the binder, where the % by volume of the metal powder and the binder add up to 100%.

The mixture may be prepared by any method known to the skilled person. Preferably the feedstock is produced by melting the binder and mixing in the metal powder. For example, the binder may be melted in a twin-screw extruder at temperatures of preferably from 150 to 220° C., in particular of from 170 to 200° C. The metal powder is subsequently metered in the required amount into the melt stream of the binder at temperatures in the same range. Alternatively, the binder may be melted in a sigma-kneader extruder at temperatures of preferably from 150 to 220° C., in particular of from 170 to 200° C. The metal powder is subsequently metered in the required amount into the melt stream of the binder at temperatures in the same range.

A particularly preferred apparatus for metering the metal powder comprises as essential element a transport screw which is located in a heatable metal cylinder and transports the metal powder into the melt of the binder. The above described process has the advantage over mixing of the components at room temperature and subsequent extrusion with an increase in temperature that decomposition of polyoxymethylene (POM) used as binder as a result of the high shear forces occurring in this variant is largely avoided.

The further components of the feedstock are presented in more detail below.

### Binder

According to the present invention, the feedstock comprises from 30 to 60% by volume of the binder. In a preferred embodiment, the mixture comprises from 35 to 55% by volume of the binder and particularly preferably from 36 to 50% by volume of the binder, based on the total volume of the feedstock.

According to the present invention, the binder comprises or essentially consists of (b1) from 40 to 97.5% by weight of at least one polyoxymethylene (POM), (b2) from 2 to 35% by weight of at least one polyolefin (PO), (b3) either no further polymer (FP) or from 0.5 to 20% by weight of at least one further polymer (FP), and (b4) either no dispersant or from 0 to 5% by weight of at least one dispersant, each based on the total weight of the binder, where the % by weight of (b1), (b2), (b3) and (b4) add up to 100%.

In a preferred embodiment, the binder comprises or essentially consists of (b1) from 62 to 94.95% by weight of at least one polyoxymethylene (POM), (b2) from 3 to 20% by weight of at least one polyolefin (PO), (b3) either no further polymer (FP) or from 2 to 15% by weight of at least one further polymer (FP) and (b4) from 0.05 to 3% by weight of at least one dispersant, each based on the total weight of the binder, where the % by weight of components (b1), (b2), (b3), and (b4) usually add up to 100%.

Particularly preferably, the binder comprises or essentially consists of (b1) from 83 to 92.9% by weight of at least one polyoxymethylene (POM), (b2) from 4 to 15% by weight of at least one polyolefin (PO) and (b3) from 3 to 10% by weight of at least one further polymer (FP) and (b4) from 0.1 to 2% by weight of at least one dispersant, each based on the total weight of the binder (B), where the % by weight of components (b1), (b2), (b3) and (b4) add up to 100%.

According to the present invention, the POM differs from the PO, PO differs from the FP, the FP differs from the dispersant and the dispersant differs from the POM. However, POM, PO, FP and the dispersant may comprise identical building units and, for example, differ in a further building unit and/or differ in the molecular weight.

The components (b1) POM, (b2) PE, (b3) FP, and (b4) dispersant of the binder are described in more detail below.

### Polyoxymethylene

According to the present invention, the binder comprises from 40 to 97.5% by weight of Polyoxymethylene (also referred to herein as “POM”). In a preferred embodiment, the binder comprises from 62 to 94.95% by weight of POM and particularly preferably from 83 to 92.9% by weight of POM, based on the total amount of the binder.

At least one POM may be used in the binder. “At least one POM” within the present invention means precisely one POM and also mixtures of two or more POMs.

For the purpose of the present invention, the term “polyoxymethylene” or “POM” encompasses both, POM itself, i. e. polyoxymethylene homopolymers, and polyoxymethylene copolymers and polyoxymethylene terpolymers.

POM homopolymers usually are prepared by polymerization of a monomer selected from a formaldehyde source.

The term “formaldehyde source” relates to substances which can liberate formaldehyde under the reaction conditions of the preparation of POM.

The formaldehyde sources are advantageously selected from the group of cyclic or linear formals, in particular from the group consisting of formaldehyde and 1,3,5-trioxane. 1,3,5-trioxane is particularly preferred.

POM copolymers are known per se and are commercially available. They are usually prepared by polymerization of trioxane as main monomer. In addition, comonomers are concomitantly used. The main monomers are preferably selected from among trioxane and other cyclic or linear formals or other formaldehyde sources.

The expression “main monomers” is intended to indicate that the proportion of these monomers in the total amount of monomers, i. e. the sum of main monomers and comonomers, is greater than the proportion of the comonomers in the total amount of monomers.

Quite generally, the POM according to the present invention has at least 50 mol % of repeating units —CH₂O— in the main polymer chain. Suitable polyoxymethylene (POM) copolymers are in particular those which comprise the repeating units —CH₂O— and from 0.01 to 20 mol %, in particular from 0.1 to 10 mol % and very particularly preferably from 0.5 to 6 mol % of repeating units of the formula (I),

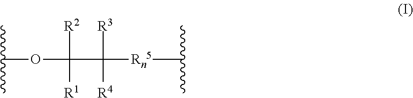

wherein
R¹ to R⁴ are each independently of one another selected from the group consisting of H. C₁ C₄ alkyl and halogen-substituted C₁ C₄ alkyl;
R⁵ is selected from the group consisting of a chemical bond, a (—CR^{5a}R^{5b}—) group and a (—CR^{5a}R^{5b}O—) group,
R^{5a} and R^{5b} are each independently of one another selected from the group consisting of H and unsubstituted or at least monosubstituted C₁ C₄ alkyl, wherein the substituents are selected from the group consisting of F, Cl, Br, OH and C₁ C₄ alkyl; and
n is 0, 1, 2 or 3.

If n is 0, then R⁵ is a chemical bond between the adjacent carbon atom and the oxygen atom. If R⁵ is a (—CR^{5a}R^{5b}O—) group, then the oxygen atom (0) of the (—CR^{5a}R^{5b}O—) group is bound to another carbon atom (C) of formula (I) and not to the oxygen atom (O) of formula (I). In other words, formula (I) does not comprise peroxide compounds. The same holds true for formula (II).

Within the context of the present invention, definitions such as C₁ C₄ alkyl, as for example defined above for the radicals R¹ to R⁴ in formula (I), mean that this substituent (radical) is an alkyl radical with a carbon atom number from 1 to 4. The alkyl radical may be linear or branched and also optionally cyclic. Alkyl radicals which have both a cyclic component and also a linear component likewise fall under this definition. Examples of alkyl radicals are methyl, ethyl, n-propyl, iso-propyl, butyl, iso butyl, sec butyl and tert butyl.

In the context of the present invention, definitions, such as halogen-substituted C₁-C₄-alkyls, as for example defined above for the radicals R¹ to R⁴ in formula (I), mean that the C₁ C₄ alkyl is substituted by at least one halogen. Halogens are F (fluorine), Cl (chlorine), Br (bromine) and I (iodine).

The repeating units of formula (I) can advantageously be introduced into the POM copolymers by ring-opening of cyclic ethers as first comonomers. Preference is given to first comonomers of the general formula (II),

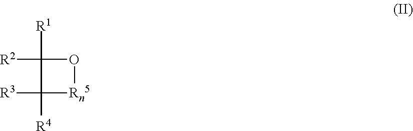

wherein R¹ to R⁵ and n have the meanings as defined above for the general formula (I).

As first comonomers mention may be made for example of ethylene oxide, 1,2-propylene oxide, 1,2-butylene oxide, 1,3-butylene oxide, 1,3-dioxane, 1,3-dioxolane and 1,3-dioxepane as cyclic ethers and also linear oligoformals or polyformals such as polydioxolane or polydioxepane. 1,3 dioxolane and 1,3 dioxepane are particularly preferred first comonomers, very particular preferred is 1,3 dioxolane as first comonomer.

POM polymers which can be obtained by reaction of a formaldehyde source together with the first comonomer and a second comonomer are likewise suitable. The addition of the second comonomer makes it possible to prepare, in particular, POM terpolymers.

The second comonomer is preferably selected from the group consisting of a compound of formula (III) and a compound of formula (IV),

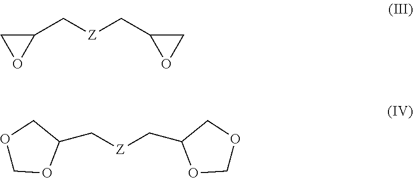

wherein Z is selected from the group consisting of a chemical bond, an (—O—) group and an (—OR⁶O—) group, wherein R⁶ is selected from the group consisting of unsubstituted C₁ C₈ alkanediyl and C₃ C₈ cycloalkanediyl.

The C₁ C₈ alkanediyl is a hydrocarbon having two free valences and a carbon atom number of from 1 to 8. The C₁ C₈ alkanediyl according to the present invention can be branched or unbranched.

A C₃ C₈ cycloalkanediyl is a cyclic hydrocarbon having two free valences and a carbon atom number of from 3 to 8. Hydrocarbons having two free valences, a cyclic and also a linear component, and a carbon atom number of from 3 to 8 likewise fall under this definition.

Preferred examples of the second comonomer (b1c) are ethylene diglycidyl, diglycidyl ether and diethers prepared from glycidyl compounds and formaldehyde, dioxane or trioxane in a molar ratio of 2:1 and likewise diethers prepared from 2 mol of a glycidyl compound and 1 mol of an aliphatic diol having from 2 to 8 carbon atoms, for example the diglycidyl ether of ethylene glycol, 1,4 butanediol, 1,3 butanediol, 1,3 cyclobutanediol, 1,2 propanediol and 1,4 cyclohexanediol.

In a preferred embodiment component (b1) is a polyoxymethylene (POM) copolymer which is prepared by polymerization of from at least 50 mol-% of a formaldehyde source, from 0.01 to 20 mol-% of at least one first comonomer (b1b) and from 0 to 20 mol-% of at least one second comonomer (b1c).

In a particularly preferred embodiment the POM may be a POM copolymer which is prepared by polymerization of from 80 to 99.98 mol-%, preferably from 88 to 99 mol-% of a formaldehyde source, from 0.1 to 10 mol-%, preferably from 0.5 to 6 mol-% of at least one first comonomer and from 0.1 to 10 mol-%, preferably from 0,5 to 6 mol-% of at least one second comonomer.

In a further preferred embodiment the POM may be a POM copolymer which is prepared by polymerization of from at least 50 mol-% of a formaldehyde source, from 0.01 to 20 mol-% of at least one first comonomer of the general formula (II) and from 0 to 20 mol-% of at least one second comonomer selected from the group consisting of a compound of formula (III) and a compound of formula (IV).

In a preferred embodiment of the present invention at least some of the OH-end groups of the POM are capped. Methods for capping OH-end groups are known to the skilled person. For example, the OH-end groups can be capped by etherification or esterification.

Preferred POM copolymers have melting points of at least 150° C. and weight average molecular weights MW in the range from 5 000 g/mol to 300 000 g/mol, preferably from 6 000 g/mol to 150 000 g/mol, particularly preferably in the range from 7 000 g/mol to 100 000 g/mol.

Particular preference is given to POM copolymers having a polydispersity (Mw/Mn) of from 2 to 15, preferably from 2.5 to 12, particularly preferably from 3 to 9.

The measurement of the weight average molecular weight (Mw) and the number average molecular weight (Mn) is generally carried out by gel permeation chromatography (GPC). GPC is also known as sized exclusion chromatography (SEC).

Methods for the preparation of POM are known to those skilled in the art.

### Polyolefin

According to the present invention, the binder comprises from 2 to 35% by weight of polyolefin (also referred to herein as “PE”). In a preferred embodiment, the binder comprises from 3 to 20% by weight of the polyolefin and particularly preferably from 4 to 15% by weight of the polyolefin, based on the total amount of the binder.

According to the present invention, the polyolefin is at least one polyolefin. “At least one polyolefin” within the present invention means precisely one polyolefin and also mixtures of two or more polyolefins.

Polyolefins are known per se and are commercially available. They are usually prepared by polymerization of C₂ C₈ alkene monomers, preferably by polymerization of C₂ C₄ alkene monomers.

Within the context of the present invention, C₂ C₈ alkene means unsubstituted or at least monosubstituted hydrocarbons having 2 to 8 carbon atoms and at least one carbon-carbon double bond (C═C double bond). “At least one carbon-carbon double bond” means precisely one carbon-carbon double bond and also two or more carbon-carbon double bonds.

In other words, C₂ C₈ alkene means that the hydrocarbons having 2 to 8 carbon atoms are unsaturated. The hydrocarbons may be branched or unbranched. Examples for C₂ C₈ alkenes with one C═C-double bond are ethene, propene, 1-butene, 2-butene, 2 methyl-propene (=isobutylene), 1-pentene, 2-pentene, 2-methyl-1-butene, 3-methyl-1-butene, 1-hexene, 2-hexene, 3-hexene and 4-methyl-1-pentene. Examples for C₂ C₈ alkenes having two or more C—C-double bonds are allene, 1,3-butadiene, 1,4-pentadiene, 1,3 pentadiene, 2-methyl-1,3-butadiene (=isoprene).

If the C₂ C₈ alkenes have one C═C double bond, the polyolefins prepared from those monomers are linear. If more than one double bond is present in the C₂-C₈alkenes, the polyolefins prepared from those monomers may be crosslinked. Linear polyolefins are preferred.

It is also possible to use polyolefin copolymers, which are prepared by using different C₂ C₈ alkene monomers during the preparation of the polyolefins.

Preferably, the polyolefins are selected from the group consisting of polymethylpentene, poly-1-butene, polyisobutylene, polyethylene and polypropylene.

Particular preference is given to polyethylene and polypropylene and also their copolymers as are known to those skilled in the art and are commercially available.

The polyolefins may be prepared by any polymerization process known to the skilled person, preferably by free radical polymerization, for example by emulsion, bead, solution or bulk polymerization. Possible initiators may be, depending on the monomers and the type of polymerization, free radical initiators such as peroxy compounds and azo compounds with the amounts of initiator generally being in the range from 0.001 to 0.5% by weight, based on the monomers.

### Further Polymer

The binder may comprise from 0.5 to 20% by weight of a further polymer. In a preferred embodiment, the binder comprises from 2 to 15% by weight of the further polymer and particularly preferably from 3 to 10% by weight of the further polymer, based on the total amount of the binder.

The further polymer according to the present invention is at least one further polymer. “At least one further polymer” within the present invention means precisely one further polymer and also mixtures of two or more further polymers.

As already stated above, the at least one further polymer differs from the polyoxymethylene, the polyolefin and the dispersant describe below.

According to the present invention, the at least one further polymer is preferably selected from the group consisting of a polyether, a polyurethane, a polyepoxide, a polyamide, a vinyl aromatic polymer, a poly(vinyl ester), a poly(vinyl ether), a poly(alkyl(meth)acrylate) and copolymers thereof.

Preferably, the further polymer is selected from the group consisting of a poly(C₂-C₆ alkylene oxide), an aliphatic polyurethane, an aliphatic uncrosslinked epoxide, an aliphatic polyamide, a vinyl aromatic polymer, a poly(vinyl ester) of an aliphatic C₁-C₈ carboxylic acid, a poly(vinyl ether) of a C₁-C₈ alkyl vinyl ether, a poly(alkyl(meth)acrylate) of a C₁₋₈ alkyl and copolymers thereof.

Preferred further polymers are described in more detail below.

Polyethers comprise repeating units of formula (V).

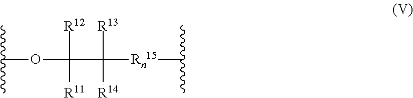

wherein
R¹¹ to R¹⁴ are each independently of one another selected from the group consisting of H, C₁ C₄ alkyl and halogen-substituted C₁ C₄ alkyl;
R¹⁵ is selected from the group consisting of a chemical bond, a (—CR^{15a}R^{15b}—) group and a (—CR^{15a}R^{15b}O—) group,
wherein
R^{15a} and R^{15b} are each independently of one another selected from the group consisting of H and unsubstituted or at least monosubstituted C₁ C₄ alkyl, wherein the substituents are selected from the group consisting of F, Cl, Br, OH and C₁ C₄ alkyl; and
n is 0, 1, 2 or 3.

If n is 0, then R¹⁵ is a chemical bond between the adjacent carbon atom and the oxygen atom. If R¹⁵ is a (—CR^{15a}R^{15b}O—) group, then the oxygen atom (O) of the (—CR^{15a}R^{15b}O—) group is bound to another carbon atom (C) of formula (V) and not to the oxygen atom (O) of formula (V). In other words, formula (V) does not comprise peroxide compounds. The same holds true for formula (VI).

Typical polyethers as well as their preparation are known to the skilled person.

A preferred polyether according to the present invention is, for example, a poly(alkylene glycol), also known as a poly(alkylene oxide).

Polyalkylene oxides and their preparation are known to the skilled person. They are usually synthesized by interaction of water and a bi- or polyvalent alcohol with cyclic ethers, i. e. alkylene oxides, of the general formula (VI). The reaction is catalyzed by an acidic or basic catalyst. The reaction is a so called ring-opening polymerization of the cyclic ether of the general formula (VI).

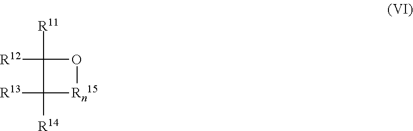

wherein
R¹¹ to R¹⁵ have the same meanings as defined above for formula (V).

A preferred poly(alkylene oxide) according to the present invention is derived from monomers of the general formula (VI) having 2 to 6 carbon atoms in the ring. In other words, preferably, the poly(alkylene oxide) is a poly(C₂-C₆ alkylene oxide). Particular preference is given to a poly(alkylene oxide) derived from monomers selected from the group consisting of 1,3 dioxolane, 1,3 dioxepane and tetrahydrofuran (IUPAC-name: oxolane). In other words, particularly preferably, the poly(alkylene oxide) is selected from the group consisting of poly-1,3 dioxolane, poly-1,3 dioxepane and polytetrahydrofuran.

In one embodiment, the poly(alkylene oxide) can comprise OH-end groups. In another embodiment, at least some of the OH-end groups of the poly(alkylene oxide) can be capped. Methods for capping OH-end groups are known to the skilled person. For example, the OH-end groups can be capped by etherification or esterification.

The weight average molecular weight of the poly(alkylene oxide) is preferably in the range of from 1 000 to 100 000 g/mol, particular preferably from 1 200 to 80 000 g/mol and more preferably in the range of from 1 500 to 50 000 g/mol.

A polyurethane is a polymer having carbamate units. Polyurethanes as well as their preparation is known to the skilled person.

Within the present invention, aliphatic polyurethanes are preferred. They can, for example, be prepared by polyaddition of aliphatic polyisocyanates and aliphatic polyhydroxy compounds. Among the polyisocyanates, diisocyanates of the general formula (VII) are preferred

OCN—R⁷—NCO (VII),
wherein
R⁷ is a substituted or unsubstituted C₁-C₂₀ alkanediyl or C₄-C₂₀ cycloalkanediyl, wherein the substituents are selected from the group consisting of F, Cl, Br and C₁ C₆ alkyl.

Preferably R⁷ is a substituted or unsubstituted C₂ C₁₂ alkandiyl or C₆ C₁₅ cycloalkanediyl.

The C₁ C₂₀ alkanediyl is a hydrocarbon having two free valences and a carbon atom number of from 1 to 20. The C₁ C₂₀ alkyanediyl according to the present invention can be branched or unbranched.

Within the context of the present invention, definitions such as C₄-C₂₀ cycloalkanediyl means C₄ C₂₀ cycloalkanediyle. A C₄ C₂₀ cycloalkanediyl is a cyclic hydrocarbon having two free valences and a carbon atom number of from 4 to 20. Hydrocarbons having two free valences, a cyclic and also a linear component and a carbon atom number of from 4 to 20 likewise fall under this definition.

Preferred diisocyanates are selected from the group consisting of hexamethylene diisocyanate, 2,2,4 trimethyl hexamethylene diisocyanate, 2,4,4 trimethyl hexamethylene diisocyanate, 1,2-diisocyanatomethyl cyclohexane, 1,4 diisocyanatomethyl cyclohexane and isophoron diisocyanate (IUPAC-name: 5-iso-cyanato 1 (isocyanatomethyl) 1,3,3 trimethyl-cyclohexane).

The diisocyanates may also be used in oligomeric, for example dimeric or trimeric form. Instead of the polyisocyanates, it is also possible to use conventional blocked polyisocyanates which are obtained from the stated isocyanates, for example by an addition reaction of phenol or caprolactam.

Suitable polyhydroxy compounds for the preparation of aliphatic polyurethanes are, for example, polyesters, polyethers, polyesteramides or polyacetales or mixtures thereof.

Suitable chain extenders for the preparation of the polyurethanes are low molecular weight polyols, in particular diols and polyamines, in particular diamines or water.

The polyurethanes are preferably thermoplastic and therefore preferably essentially uncrosslinked, i. e. they can be melted repeatedly without significant signs of decomposition. Their reduced specific viscosities are as a rule from 0.5 to 3 dl/g, preferably from 1 to 2 dl/g measured at 30° C. in dimethylformamide.

A polyepoxide comprises at least two epoxide groups. The epoxide groups are also known as glycidyl or oxirane groups. “At least two epoxide groups” mean precisely two epoxide groups and also three or more epoxide groups.

Polyepoxides and their preparation is known to the person skilled in the art. For example, polyepoxides are prepared by the reaction of epichlorhydrine (IUPAC-name: chlormethyloxirane) and a diol, a polyol or a dicarboxylic acid. Polyepoxides prepared in this way are polyethers having epoxide end groups.

Another possibility to prepare polyepoxides is the reaction of glycidyl(meth)acrylate (IUPAC-name: oxiran-2-ylmethyl-2-methylprop-2-enoate) with polyolefins or polyacrylates. This results in polyolefins or polyacrylates having epoxy end groups.

Preferably, aliphatic uncrosslinked polyepoxides are used. Copolymers of epichlorhydrine and 2,2 bis (4-hydroxyphenyl)-propane (bisphenol A) are particularly preferred.

Component (b3) (the at least one further polymer (FP)) can also comprise a polyamide. Aliphatic polyamides are preferred.

The intrinsic viscosity of suitable polyamides is generally from 150 to 350 ml/g, preferably from 180 to 275 ml/g. Intrinsic viscosity is determined here from a 0.5% by weight solution of the polyamide in 96% by weight sulfuric acid at 25° C. in accordance with ISO 307.

Preferred polyamides are semicrystalline or amorphous polyamides.

Examples of polyamides suitable as component (b3) are those that derive from lactams having from 7 to 13 ring members. Other suitable polyamides are those obtained through reaction of dicarboxylic acids with diamines.

Examples that may be mentioned of polyamides that derive from lactams are polyamides that derive from polycaprolactam, from polycaprylolactam, and/or from polylaurolactam.

If polyamides are used that are obtainable from dicarboxylic acids and diamines, dicarboxylic acids that can be used are alkanedicarboxylic acids having from 6 to 14 carbon atoms, preferably from 6 to 10 carbon atoms. Aromatic dicarboxylic acids are also suitable.

Examples that may be mentioned here as dicarboxylic acids are adipic acid, azelaic acid, sebacic acid, dodecanedicarboxylic acid, and also terephthalic acid and/or isophthalic acid.

Examples of suitable diamines are alkanediamines, having from 4 to 14 carbon atoms, in particular alkanediamines having from 6 to 8 carbon atoms, and also aromatic diamines, for example m-xylylenediamine, di(4-aminophenyl)methane, di(4-aminocyclohexyl)methane, 2,2-di(4-aminophenyl)propane, 2,2-di(4-aminocyclohexyl)-propane, and 1,5-diamino-2-methylpentane.

Other suitable polyamides are those obtainable through copolymerization of two or more of the monomers mentioned above and mentioned below, and mixtures of a plurality of polyamides in any desired mixing ratio.

Preferred polyamides are polyhexamethyleneadipamide, polyhexamethylene-sebacamide, and polycaprolactam, and also nylon 6/6,6, in particular having a proportion of from 75 to 95% by weight of caprolactam units.

Particular preference is given to mixtures of nylon 6 with other polyamides, in particular with nylon 6/6,6 (PA 6/66), particular preference being given to mixtures of from 80 to 50% by weight of PA 6 and from 20 to 50% by weight of PA 6/66, where the PA 6/66 comprises from 75 to 95% by weight of caprolactam units, based on the total weight of the PA 6/66 in the mixture.

The following, non-exclusive list comprises the abovementioned polyamides, and other suitable polyamides, and also the monomers comprised.

### AB Polymers:

| | |
|---|---|
| PA 4 | Pyrrolidone |
| PA 6 | ε-Caprolactam |
| PA 7 | Ethanolactam |
| PA 8 | Caprylolactam |
| PA 9 | 9-Aminopelargonic acid |
| PA 11 | 11-Aminoundecanoic acid |
| PA 12 | Laurolactam |

### AA/BB Polymers:

| | |
|---|---|
| PA 46 | Tetramethylenediamine, adipic acid |
| PA 66 | Hexamethylenediamine, adipic acid |
| PA 69 | Hexamethlyenediamine, azelaic acid |
| PA 610 | Hexamethylenediamine, sebacic acid |
| PA 612 | Hexamethylenediamine, decanedicarboxylic acid |
| PA 613 | Hexamethylenediamine, undecanedicarboxylic acid |
| PA 1212 | 1,12-Dodecanediamine, decanedicarboxylic acid |
| PA 1313 | 1,13-Diaminotridecane, undecanedicarboxylic acid |
| PA 6T | Hexamethylenediamine, terephthalic acid |
| PA MXD6 | m-Xylylenediamine, adipic acid |
| PA 6I | Hexamethylenediamine, isophthalic acid |
| PA 6-3-T | Trimethylhexamethylenediamine, terephthalic acid |
| PA 6/6T | (see PA 6 and PA 6T) |
| PA 6/66 | (see PA 6 and PA 66) |
| PA 6/12 | (see PA 6 and PA 12) |
| PA 66/6/610 | (see PA 66, PA 6 and PA 610) |
| PA 6I/6T | (see PA 6I and PA 6T) |
| PA PACM 6 | Diaminodicyclohexylmethane, adipic acid |
| PA PACM 12 | Diaminodicyclohexylmethane, laurolactam |
| PA 6I/6T/PACM | as PA 6I/6T + diaminodicyclohexylmethane |
| PA 12/MACMI | Laurolactam, dimethyldiaminodicyclohexylmethane, |
| | isophthalic acid |
| PA 12/MACMT | Laurolactam, dimethyldiaminodicyclohexylmethane, |
| | terephthalic acid |
| PA PDA-T | Phenylenediamine, terephthalic acid |

Preferred polyamides are PA 6, PA 66 and PA PACM 6.

Vinyl aromatic polymers are polyolefins having unsubstituted or at least monosubstituted styrene as monomer unit. Suitable substituents are, for example, C1 C6 alkyls, F, Cl, Br and OH. Preferred vinyl aromatic polymers are selected from the group consisting of polystyrene, poly-α methylstyrene and copolymers thereof with up to 30% by weight of comonomers selected from the group consisting of acrylic esters, acrylonitrile and methacrylonitrile.

Vinyl aromatic polymers are commercially available and known to the person skilled in the art. The preparation of these polymers is also known to the person skilled in the art.

Preferably, the vinyl aromatic polymers are prepared by free radical polymerization, for example by emulsion, bead, solution or bulk polymerization. Possible initiators are, depending on the monomers and the type of polymerization, free radical initiators such as peroxide compounds and azo compounds with the amounts of initiator generally being in the range from 0.001 to 0.5% by weight, based on the monomers.

Poly(vinyl esters) and their preparation are known to the skilled person. Poly(vinyl esters) are preferably prepared by polymerization of vinyl esters. In a preferred embodiment of the present invention, the vinyl esters are vinyl esters of aliphatic C1 C6 carboxylic acids. Preferred monomers are vinyl acetate and vinyl propionate. These monomers form poly(vinyl acetate) and poly(vinyl propionate) polymers.

Poly(vinyl ethers) are prepared by polymerization of vinyl ether monomers. Poly(vinyl ethers) and their preparation are known to the skilled person. In a preferred embodiment, the vinyl ethers are vinyl ethers of aliphatic C1 C8 alkyl ethers. Preferred monomers are methyl vinyl ether and ethyl vinyl ether, forming poly(methyl vinyl ether) and poly(ethyl vinyl ether) during the polymerization.

Preferably, the poly(vinyl ethers) are prepared by free radical polymerization, for example by emulsion, bead, solution, suspension or bulk polymerization. Possible initiators are, depending on the monomers and the type of polymerization, free radical initiators such as peroxide compounds and azo compounds with the amounts of initiator generally being in the range from 0.001 to 0.5% by weight, based on the monomers.

Poly(alkyl(meth)acrylate) within the present invention comprises poly(alkyl acrylate), poly(alkyl methacrylates) and copolymers thereof. Poly(alkyl(meth)acrylate) comprises units derived from monomers of formula (VIII),

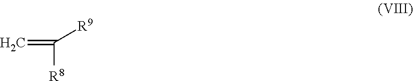

wherein
R⁸ is selected from the group consisting of H and C1 C8 alkyl and
R⁹ is a radical of formula (IX)

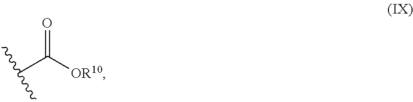

wherein R¹⁰ is a C¹ C¹⁴ alkyl.

Preferably, R⁸ is selected from the group consisting of H and C₁-C₄-alkyl, particularly preferably R⁸ is H or methyl. Preferably, R¹⁰ is a C₁-C₃-alkyl, particularly preferably, R10 is methyl or ethyl.

If R⁸ in formula (VIII) is H and R⁹ is a radical of formula (IX) and R¹⁰ in formula (IX) is methyl, then the monomer of formula (VIII) is methyl acrylate.

If R⁸ in formula (VIII) is H and R⁹ is a radical of formula (IX) and R¹⁰ in formula (IX) is ethyl, the monomer of formula (VIII) is ethyl acrylate.

If R⁸ in formula (VIII) is methyl and R⁹ is a radical of formula (IX), then the monomers of formula (VI) are methacrylic esters.

Poly(alkyl(meth)acrylates) comprise as monomers preferably 40 to 100% by weight of methacrylic esters, particularly preferably 70 to 100% by weight of methacrylic esters and more preferably from 80 to 100% by weight of methacrylic esters, each based on the total amount of the poly(alkyl(meth)acrylates).

In another preferred embodiment, the poly(alkyl(meth)acrylates) comprise as monomers from 20 to 100% by weight of methyl acrylate, ethyl acrylate or a mixture thereof, preferably from 40 to 100% by weight of methyl acrylate, ethyl acrylate or a mixture thereof and particularly preferably from 50 to 100% by weight of methyl acrylate, ethyl acrylate or mixtures of thereof, each based on the total weight of the poly(alkyl(meth)acrylate).

The person skilled in the art knows that the monomers described above for the preparation of the components (b1), (b2) and (b3) can undergo changes in their structure during the polymerization reaction. Consequently, the building units of the polymers are not the same as the monomers from which they are derived. However, the person skilled in the art knows which monomers correspond to which building unit of the polymers.

Under the conditions of compounding or processing by injection molding, virtually no transacetalization occurs between component (b1), the polyoxymethylene (POM), and component (b3), the at least one further polymer (FP), i. e. virtually no exchange of comonomer units takes place.

In another embodiment of the present invention that is a particular useful for fused filament fabrication processes the at least one further polymer (FP) is selected from the group consisting of a polyether, a polyurethane, a polyepoxide, a polyamide, a vinyl aromatic polymer, a poly(vinyl ester), a poly(vinyl ether), a poly(alkyl (meth)acrylate) and copolymers thereof.

### Dispersant

In one embodiment of the present invention, the mixture may comprise from 0 to 5% by volume of a dispersant. In a preferred embodiment, the mixture comprises from 0.05 to 3% by volume of the dispersant and particularly preferably from 0.1 to 3% by volume of the dispersant, each based on the total volume of the mixture.

As the dispersant one or more dispersants may be used.

Useful dispersants are generally known in the art. Examples are oligomeric polyethylene oxide having a low molecular weight of from 200 to 600 g/mol stearic acid, stearamides, hydroxystearic acids, fatty alcohols, fatty alcohol sulfonates and block copolymers of ethylene oxide and propylene oxide and also, particularly preferably, fatty acid esters.

### Metal Injection Molding Process

Metal Injection Molding of the MIM feedstock is carried out following the steps:
(I) providing a composition as describe herein;
(II) injection molding the composition to form a green body;
(III) catalytically debinding the green body with an acid to form a brown body;
(IV) sintering the brown body under a non-oxidative atmosphere, atmospheric or reduced pressure, and a temperature of from 1 150 to 1 300° C. to form a sintered part;
(V) heat-treating the sintered parts with a solution annealing and/or precipitation hardening process.

### Injection Molding

Process step (II) is typically performed using conventional screw or plunger injection-molding machines and processes known in the art. Preferably, mold temperatures of from 80° C. to 140° C. and screw temperatures of from 160 to 200° C. and injection pressures of from 500 to 2000 bar are utilized. Through this process, a three-dimensional green body is produced.

### Debinding

Process step (II) is followed by a process step (III) in which at least part of the binder is removed from the three-dimensional green body. The at least partial removal of the binder is also called catalytic debinding. The terms “process step (III)” and “catalytic debinding” for the purpose of the present invention are synonymous and are used interchangeably throughout the present invention.

To remove at least part of the binder in process step (III), the three-dimensional green body is preferably treated with a gaseous acid comprising atmosphere. Appropriate processes are described, for example, in US 2009/0288739 and U.S. Pat. No. 5,145,900. This process step (III) is, according to the invention, preferably carried out at temperatures below the melting temperature of the binder. In general, the process step (III) is carried out at a temperature in the range of from 20 to 150° C. and particularly preferably of from 100 to 140° C. Preferably, process step (III) is carried out for a period of from 0.1 to 24 h, particularly preferably of from 0.5 to 12 h.

The treatment time required depends on the treatment temperature and the concentration of the acid in the treatment atmosphere and also on the size of the three-dimensional object.

Suitable acids for process step (III) of the present invention are, for example, inorganic acids which are either gaseous at room temperature or can be vaporized at the treatment temperature or below. Examples are hydrogen halides and nitric acid. Hydrogen halides are hydrogen fluoride, hydrogen chloride, hydrogen bromide and hydrogen iodide. Suitable organic acids are those, which have a boiling point at atmosphere pressure of less than 130° C., e. g. formic acid, acetic acid or trifluoroacetic acid and mixtures thereof. Acids with boiling points above 130° C., for example methanesulfonic acid, can also be utilized in process step (III) when dosed as a mixture with a lower boiling acid and/or water. Preferred acids for process step (III) are nitric acid, a 10% by weight solution of oxalic acid in water or a mixture of 50% by volume of methanesulforic acid in water.

Furthermore, BF₃ and its adducts with inorganic ethers can be used as acids.

If a carrier gas is used, the carrier gas is generally passed through the acid and loaded with the acid beforehand. The carrier gas, which has been loaded in this way with the acid, is then brought to the temperature at which process step (III) is carried out. This temperature is advantageously higher than the loading temperature in order to avoid condensation of the acids. Preferably the temperature at which process step (iv) is carried out is at least 1° C., particularly preferably at least 5° C. and most preferably at least 10° C. higher than the loading temperature.

Preference is given to mixing the acid into the carrier gas by means of a metering device and heating the gas mixture to such a temperature that the acid can no longer condense. Preferably the temperature is at least 1° C., particularly preferably at least 5° C. and most preferably at least 10° C. higher than the sublimation and/or vaporization temperature of the acid and/or the carrier gas.

The carrier gas in general is any gas that is inert under the reaction conditions of the catalytic debinding step. A preferred carrier gas according to the present invention is nitrogen. The binder removal can also be carried out under reduced pressure.

The catalytic debinding is preferably continued until the polyoxymethylene (POM) of the binder has been removed to an extent of at least 80% by weight, preferably at least 90% by weight, particularly preferably at least 95% by weight, based on the total weight of the POM. This may be checked, for example, with the height of the weight decrease.

It is known to the skilled person that at the temperatures of the catalytic debinding step, the metal powder comprised in the three-dimensional green body may undergo chemical and/or physical reactions. In particular, the particles of the metal powder may fuse together, undergo solid state phase transitions and/or chemical reactions with the acidic atmosphere or carrier gas.

The same holds true for the binder. During the catalytic debinding step the composition of the binder may change.

### Additive Manufacturing

Besides MIM, additive manufacturing methods including fused filament fabrication based on filament, rod/bar and granulate extrusions may be employed to prepare the green bodies from the feedstocks described above. The use of such feedstocks in additive manufacturing is generally described in WO 2016/012486, which is incorporated herein by reference.

### BBJ Process

As an alternative to the use of the pre-formulated feedstocks, the metal powder may be used in-situ in an binder-into-bed jetting process without any pre-formulation including a binder to prepare the green bodies as described in U.S. Pat. No. 5,204,055 and further detailed below.

The metal powders described above may be introduced directly into the binder-into-bed jetting (also referred to herein as “BBJ”) process which can be described by the following steps:
1.) Depositing a layer of the metal powder in a confined region;
2.) Applying a binder to one or more selected regions of said layer of powder material via an inkjet-printing like mechanism which will cause the said layer of the metal powder to become bonded at said one or more selected regions;
3.) Repeating steps 1 and 2 a selected number of times to produce a selected number of layers, said further material causing said successive layers to become bonded to each other;
4.) Removing unbonded metal powder which is not as said one or more selected regions to provide the final green body.

In BBJ systems typical binders include polymeric resins, either water soluble such as cellulosic binders or solvent-base such as butyral resins. Reactive systems such as tetraethylorthosilicates or other silicates may also be used.

For the BBJ process, green parts can either be introduced into the sintering process described below for the MIM process or slight variations of this process, specifically in the duration and speed of steps (i) and (ii). The heat treatments described below for the MIM process can be used for sinter parts made via the BBJ and sintering route.

### Sintering

Process step (III) may be followed by a process step (IV) in which the three-dimensional brown body is sintered. Process step (IV) is also called “sintering”. The terms “process step (IV)” and “sintering” for the purpose of the present invention are synonymous and are used interchangeably throughout the present invention.

After the sintering, the three-dimensional object is a three-dimensional sintered body. The three-dimensional sintered body comprises the consolidated form of the initial metal powder and is essentially free of the binder.

“Essentially free of the binder” according to the present invention means that the three-dimensional sintered body comprises less than 5% by volume, preferably less than 2% by volume, particularly preferably less than 0.5% by volume and most preferably less than 0.01% by volume of the binder.

It is known to the skilled person that during the sintering process the metal powder is sintered together to give a sintered inorganic powder. Furthermore, during the sintering process the metal powder can undergo chemical and/or physical reactions. Consequently, the metal powder comprised in the three-dimensional brown body usually differs from the sintered inorganic powder comprised in the three-dimensional sintered body.

In one embodiment of the present invention, after process step (III) and before process step (IV), the three-dimensional brown body obtained in process step (III) may be heated for preferably 0.1 to 12 h, particularly preferably from 0.3 to 6 h, at a temperature of preferably from 250 to 700° C., particularly preferably from 250 to 600° C. to remove the residual binder completely.

In one embodiment of the present invention, process step (IV) is defined by the following temperature profile:
i. heating to a temperature of from 550 to 650° C. at a rate of from 2 to 7° C./min,
ii. holding at the temperature from 550 to 650° C. for 0.5 to 1.5 h,
iii. heating to a temperature of from 1 150 to 1 300° C. at a rate of 2 to 7° C./min,
iv. holding at the temperature of from 1 150 to 1 300° C. for 0.5 h to 1.5 h, and
v. cooling down to ambient temperature at a rate of from 5 to 15° C./min.

Preferably process step (IV) is defined by the following temperature profile:
i. heating to a temperature of from 550 to 650° C. at a rate of from 2 to 7° C./min,
ii. holding at the temperature from 550 to 650° C. for 0.5 to 1.5 h,
iii. heating to a temperature of from 1 200 to 1 250° C. at a rate of 2 to 7° C./min,
iv. holding at the temperature of from 1 200 to 1 250° C. for 0.5 h to 1.5 h, and
v. cooling down to ambient temperature at a rate of from 5 to 15° C./min.

Process step (IV) is preferably performed using an atmosphere of hydrogen or argon and atmospheric pressures. The use of reduced pressures is also possible.

### Post Treatment

Finally, the target properties are best met when performing an optional final process step (V) including a heat treatment of the metal parts received after process step (IV). Preferable heat treatments include an annealing and/or a precipitation-hardening step.

The annealing step may preferably be performed in a non-oxidative atmosphere, such as but not limited to an argon or nitrogen atmosphere. The annealing step may preferably be performed at a temperature of from 800 and 1 200° C. for 15 to 60 min.

The precipitation-hardening step may preferably be performed between 450 and 550° C. for between 30 min to 5 hours, particularly in but not limited to nitrogen, argon or air.

In one embodiment of the present invention, process step (V) is defined by the following temperature profile and conditions:
(i) a solution annealing step performed in argon or nitrogen at a temperature of from 800 to 1 200° C. for 15 min to 60 min, and
(ii) a precipitation-hardening step performed in air, argon or nitrogen at a temperature of from 450 to 550° C. for 10 min to 2 h.

By using the aspects of the inventions metal parts having a density of 7.4 g/cm³ or less, preferably 7.0 g/cm³ or less, most preferably 6.9 g/cm³ or less may be produced. Furthermore, metal parts having a tensile strength of 600 MPa or more, preferably 700 MPa or more, more preferably 750 MPa or more, most preferably 800 MPa or more may be received. Finally, the metal parts according to the invention may have a ductility (elongation at break) of 5% or more, preferably 10% or more, more preferably 12% or more, even more preferably 15% or more, most preferably 18% or more.

All percent, ppm or comparable values refer to the weight with respect to the total weight of the respective composition except where otherwise indicated. All cited documents are incorporated herein by reference.

The following examples shall further illustrate the present invention without restricting the scope of this invention.

### EXAMPLES

The melt flow rate (MFR) was measured according to ISO 1133-1 using 190° C. and 21.6 kg.

The tensile strength, yield strength and elongation to break was measure according to ISO 6892-1:2019 B.

The particles sizes of the metal powder were determined by static light scattering measurements performed on a Beckman Coulter LS 13320.

The chemical composition of the metal powders was determined using induction-coupled plasma—optical electron spectroscopy performed on an Agilent 5110.

The gas atomized metal powders were procured with properties given in Table 1 below.

TABLE 1

| | Al | Mn | C | Cr | Si | Ti | D50 |
|---|---|---|---|---|---|---|---|
| MP1 | 6.6 | 16.8 | 1.08 | 5.9 | 0.8 | 0.28 | 10.2 |
| MP2 | 7.8 | 22.5 | 1.08 | 6.2 | 1.1 | 0.25 | 10.3 |

These powders were converted into MIM feedstocks by blending with the binder comprising 7-8 wt % POM, 0.7-0.8 wt % PE and 0.25-0.3 wt % additives in a sigma-kneader. A metal powder loading of 63.7 vol % was targeted. Resultant properties of the feedstock are shown in Table 2 below.

TABLE 2

| | MP | MFR [g/10 min] |
|---|---|---|
| Feedstock 1 | 1 | 1020 |
| Feedstock 2 | 2 | 1034 |

Feedstocks 1 and 2 were injection molded using an injection pressure between 900 and 1000 bar, a pack pressure between 800 and 100 bar, a nozzle temperature of around 190° C., a mold temperature of around 125° C. and screw speeds of between 8 and 12 m/min to make a green body shape.

These green bodies were sintered in a Molybdenum furnace under either argon or hydrogen atmosphere. The following temperature profile was utilized:
i. heating from room temperature to 600° C. at 5° C./min, and
ii. holding at 600° C. for 1 h,
iii. heating from 600° C. to between 1220 and 1250° C., at with 5° C./min,
iv. holding at between 1220 and 1250° C. for 1 hour, and finally
v. a furnace cool to ambient temperature of between 5 and 15° C./min.

The influence the sintering atmosphere and temperature has on the final metal part sinter density (SD) can be seen in the Table 3 below:

TABLE 3

| | | Max. Temperature | SD |
|---|---|---|---|
| Feedstock | Atmosphere | [° C.] | [g/cm³] |
| 1 | H₂ | 1220 | 6.55 |
| | | 1235 | 6.85 |
| | Ar | 1220 | 6.56 |
| | | 1235 | 6.80 |
| 2 | H₂ | 1220 | 6.79 |
| | | 1235 | 6.72 |
| | Ar | 1220 | 6.79 |
| | | 1235 | 6.79 |

From Table 3, it is clear that changing between a maximum temperature of 1220 and 1235° C., changes in the density occurs for both feedstocks. The following trends can be seen:
Slight differences can be observed between sintering in argon and hydrogen for feedstock 2, which exhibits a slightly lower density in hydrogen at higher temperatures.
Feedstock 1 has a lower sinter density than feedstock 2 (in both atmospheres) at 1220° C., but a higher density than feedstock 2 at 1235° C. (in both atmospheres)

Metal parts produced by sintering feedstocks 1 and 2 at 1235° C. under argon atmosphere where further heat treated. Details of the various heat treatment conditions and the impact these and the sintering densities have on the mechanical properties of the final parts is given in Table 4 below:

TABLE 4

| | | Solution | Precipitation | Precipitation | | | |
|---|---|---|---|---|---|---|---|
| | | annealing | hardening | hardening | Tensile | Yield | Elongation |
| Feed- | SD | temperature | temperature | time | strength | strength | at break |
| stock | [g/cm³] | [° C.] * | [° C.] | [min] | [MPa] | [MPa] | [%] |
| 1 | 6.80 | 1100 | n/a | 0 | 901 | 588 | 23 |
| | 6.80 | 1100 | 450 | 60 | 876 | 628 | 21 |
| | 6.80 | 1100 | 550 | 10 | 909 | 623 | 22 |
| | 6.80 | 1100 | 550 | 60 | 888 | 625 | 20 |
| 2 | 6.79 | 1100 | n/a | 0 | 868 | 638 | 22 |
| | 6.79 | 1100 | 450 | 60 | 868 | 686 | 21 |
| | 6.79 | 1100 | 550 | 10 | 873 | 726 | 19 |
| | 6.79 | 1100 | 550 | 60 | 870 | 767 | 15 |

* Solution annealing time was 30 min.

From Table 4 it is clear that a minimum tensile strength of 600 MPa can be achieved using a wide range of heat treatment programs for both Feedstock 1 and 2. Very high ductilities (elongations at break) can simultaneously be achieved.

1.-15. (canceled)

16. A composition comprising
(a) from 40 to 70% by volume of a metal powder, based on the total volume of the composition, in which the metal powder is an alloy comprising:
(a1) from 4.0 to 13.0% by weight of chromium,
(a2) from 6 to 15% by weight of aluminium,
(a3) from 4 to 30% by weight of manganese,
(a4) from 38.4 to 85.95% by weight of iron,
(a5) from 0.05 to 0.5% by weight of titanium,
(a6) from 0 to 0.2% by weight of nickel,
(a7) from 0 to 1.5% by weight of silicon,
(a8) from 0 to 1.5% by weight carbon,
all based on the total weight of the metal powder; and
(b) from 30 to 60% by volume, based on the total volume of the composition, of a polymeric binder.

17. The composition according to claim 16, wherein the alloy comprises
(a1) from 4.5 to 11.0% by weight of chromium,
(a2) from 6.2 to 13% by weight of aluminum,
(a3) from 6 to 28% by weight of manganese,
(a4) from 44.65 to 82.3% by weight of iron,
(a5) from 0.1 to 0.4% by weight of titanium,
(a6) from 0 to 0.15% by weight of nickel,
(a7) from 0.4 to 1.4% by weight of silicon,
(a8) from 0.5 to 1.4% by weight carbon.

18. The composition according to claim 16, wherein the alloy comprises:
(a1) from 5.0 to 9.0% by weight of chromium,
(a2) from 6.5 to 10% by weight of aluminum,
(a3) from 10 to 25% by weight of manganese,
(a4) from 52.95 to 76.95% by weight of iron,
(a5) from 0.15 to 0.35% by weight of titanium,
(a6) from 0 to 0.1% by weight of nickel,
(a7) from 0.6 to 1.3% by weight of silicon,
(a8) from 0.7 to 1.3% by weight of carbon.

19. The composition according to claim 16, wherein the alloy consists essentially of:
(a1) from 4.5 to 11.0% by weight of chromium,
(a2) from 6.2 to 13% by weight of aluminum,
(a3) from 6 to 28% by weight of manganese,
(a4) from 44.65 to 82.3% by weight of iron,
(a5) from 0.1 to 0.4% by weight of titanium,
(a6) from 0 to 0.15% by weight of nickel,
(a7) from 0.4 to 1.4% by weight of silicon,
(a8) from 0.5 to 1.4% by weight carbon,
(a9) from 0.0 to 0.6% by weight nitrogen.

20. The composition according to claim 16, wherein the polymeric binder comprises
(b1) from 40 to 97.5% by weight of at least one polyoxymethylene,
(b2) from 2 to 35% by weight of at least one polyolefin,
(b3) 0 or from 0.5 to 20% by weight of at least one further polymer,
(b4) 0 or from 0.01 to 5% by weight of at least one dispersant
all based on the total weight of the polymeric binder.

21. The composition according to claim 16, wherein the polymeric binder comprises
(b1) from 40 to 97.5% by weight of at least one polyoxymethylene,
(b2) from 2 to 35% by weight of at least one polyolefin,
(b3) 0% by weight of at least one further polymer,
(b4) from 0.01 to 5% by weight of at least one dispersant
all based on the total weight of the polymeric binder.

22. A process for metal injection molding or additive manufacturing comprising the composition according to claim 16.

23. A process for manufacturing a metal part by metal injection molding comprising
(I) providing a composition according to claim 16;
(II) injection molding the composition to form a green body;
(III) catalytically debinding the green body with an acid to form a brown body;
(IV) sintering the brown body under a non-oxidative atmosphere, atmospheric or reduced pressure, and a temperature of from 1150 to 1300° C. to form a sintered part;
(V) optionally heat-treating the sintered parts with a solution annealing and/or precipitation-hardening process.

24. A process for manufacturing a metal part by additive manufacturing comprising
(I) providing a composition according to claim 16;
(II) subjecting the composition to a fused filament fabrication step to form a green body;
(III) catalytically debinding the green body with an acid to form a brown body;
(IV) sintering the brown body under a non-oxidative atmosphere, at atmospheric or reduced pressure, and a maximum temperature of from 1150 to 1300° C. to form a sintered part;
(V) optionally heat-treating the sintered parts with a solution annealing and/or precipitation-hardening process.

25. The process according to claim 23, wherein step (IV) is performed in an argon or hydrogen atmosphere.

26. The process according to claim 23, wherein step (IV) comprises:
i. heating to a temperature of from 550 to 650° C. at a rate of from 2 to 7° C./min,
ii. holding at the temperature from 550 to 650° C. for 0.5 to 1.5 h,
iii. heating to a temperature of from 1150 to 1300° C. at a rate of 2 to 7° C./min,
iv. holding at the temperature of from 1150 to 1300° C. for 0.5 h to 1.5 h, and
v. cooling down to ambient temperature at a rate of from 5 to 15° C./min.

27. The process according to claim 23, wherein step (V) comprises
(i) a solution annealing step performed in argon or nitrogen at a temperature of from 800 to 1200° C. for 15 min to 60 min, and
(ii) a precipitation-hardening step performed in air, argon or nitrogen at a temperature of from 450 to 550° C. for 10 min to 2 h.

28. The use of a metal powder for manufacturing metal parts by a binder-into-bed jetting additive manufacturing process, wherein the metal powder consists of an alloy comprising:
(a1) from 4.0 to 13.0% by weight of chromium,
(a2) from 6 to 15% by weight of aluminium,
(a3) from 4 to 30% by weight of manganese,
(a4) from 38.4 to 85.95% by weight of iron,
(a5) 0.05 by weight to 0.5% by weight of titanium,
(a6) 0 by weight to 0.2% by weight of nickel,
(a7) 0 by weight to 1.5% by weight of silicon,
(a8) 0 by weight to 1.5% by weight carbon,
all based on the total weight of the metal powder.

29. A process for manufacturing a metal part by additive manufacturing comprising
(I) providing a metal powder, the metal powder being an alloy comprising:
(a1) from 4.0 to 13.0% by weight of chromium,
(a2) from 6 to 15% by weight of aluminium,
(a3) from 4 to 30% by weight of manganese,
(a4) from 38.4 to 85.95% by weight of iron,
(a5) from 0.05 to 0.5% by weight of titanium,
(a6) from 0 to 0.2% by weight of nickel,
(a7) from 0 to 1.5% by weight of silicon,
(a8) from 0 to 1.5% by weight carbon;
(II) subjecting the metal powder to a binder-into-bed jetting step to form a green body;
(III/IV) debinding and sintering the green body under a non-oxidative atmosphere, under atmospheric or reduced pressure, and a temperature of from 1150° C. to 1300° C. to form a sintered part;
(V) optionally heat-treating the sintered part with a solution annealing and/or precipitation-hardening process.

30. A metal part produced by a process according to claim 23, having a density of 7.4 g/cm³ or less, an ultimate tensile strength of 600 MPa or more, and an elongation at break of 5% or more.
